(19) United States
(12) Patent Application Publication
(10) Pub. No.: US 2015/0221011 A1
(43) Pub. Date: Aug. 6, 2015

(54) SYSTEM AND METHOD FOR OBTAINING BATCH INFORMATION ABOUT A PRODUCT

(71) Applicants: Colleen M. Kavanagh, San Francisco, CA (US); Jonathan Shambroom, San Francisco, CA (US)

(72) Inventors: Colleen M. Kavanagh, San Francisco, CA (US); Jonathan Shambroom, San Francisco, CA (US)

(21) Appl. No.: 14/172,818

(22) Filed: Feb. 4, 2014

(51) Int. Cl. G06Q 30/06

(52) U.S. Cl. CPC G06Q 30/0623

(57) ABSTRACT

A method and system are described that will make it easier to obtain batch information about a product that is not printed or stamped on packaging for the product at the time it is packaged for sale. This method and system make it possible for a person to obtain information not printed or stamped on the packaging for any number of reasons. Information about the product may be de-coupled from the point in time when the packaging was made or from the time of product release by the manufacturer. This method and system enable a responsive, dynamic and flexible communication pathway for growers, manufacturers, retailers and consumers to transmit or ascertain a wider array of relevant information specific to a product or food that is not on the product packaging or labels that may be relevant to a consumer or purchaser at the point of sale or consumption.

A method and system are described that will make it easier to obtain batch information about a product that is not printed or stamped on packaging for the product at the time it is packaged for sale. This method and system make it possible for a person to obtain information that was not printed or stamped on the packaging for any number of reasons. As a result, information about the product may be de-coupled from the point in time when the packaging was made or even from the time the product was released for distribution by the manufacturer. For example, the information may not be on the packaging because it may not have been known or may not have been thought important to the consumer at the time the packaging was made. This method and system enable a responsive, dynamic and flexible communication pathway for growers, manufacturers, retailers and consumers to transmit or ascertain a wider array of relevant information specific to a product or food that is not on the product packaging or labels that may be relevant to a consumer or purchaser at the point of sale or consumption. Having access to additional batch information at, for example, the point of sale, can assist people in avoiding foods or other products that contain ingredients or components that the consumer may be seeking or seeking to avoid but that are not listed on the package. A person such as a consumer at the point of sale (e.g., a supermarket or retail store) can scan an indicator on the package that identifies the batch associated with the product. The scanning can be done by any suitable device, such as a general use smartphone or a custom electronic scanner. After the indicator is scanned, indication data is sent from the smartphone or other scanning device to a remote location where batch information corresponding to the batch that is identified by the indicator is stored. Information about the batch associated with the product is then retrieved. The batch information could include, for example, information about the allergen content of the batch that was actually measured as or after the batch was produced. It can also include information about the batch that becomes relevant after production, including things such as ingredients, supply chain, waste disposal or manufacturing. Thus, the batch information could be timely information that is in addition to, more accurate, and/or more current than the information that is on the product packaging. After the batch information is retrieved at the remote location, it may be provided to a person at the point of sale or point of consumption. The person can then make a more informed decision on whether to purchase or consume the product.

### BACKGROUND

Food Allergies are Prevalent and Can Be Life Threatening. Current research estimates 12-15 million people in the United States, including 1 in 13 children, have allergies to foods. Though 160 foods have been documented as potential allergens, the vast majority of food allergies (90%) are caused by eight foods: wheat, peanuts, tree nuts, dairy, soy, eggs, fish and shellfish, and only these eight are subject to labeling requirements under the Food Allergy Labeling Consumer Protection Act or FALCPA. These eight foods are known as “major food allergens.” The allergic reactions they cause range in severity from exposure-to-exposure and person-to-person, but can include rashes, shortness of breath, or even death. Every three minutes someone in the United States goes to the emergency room due to an allergic reaction to food and 200 die each year from food-related anaphylactic shock. The Food Allergy Anaphylaxis Network (FAAN) and Food Allergy Research & Education (FARE) are among organizations that collect and distribute information about food allergies.

Many other people must avoid specific foods for health reasons as well. For example, an estimated 1 in 133 people in the United States have Celiac Disease and cannot eat any foods with gluten in them (wheat, barley, rye and some oats) without risking a multitude of often serious negative symptoms. An estimated 5-10% more of the U.S. population may be gluten intolerant and likewise need to avoid gluten in their diets to stay healthy. And, nearly 30% of Americans are choosing to avoid gluten in an effort to seek better health (NPD Group INC, survey 2012).

Lactose intolerance, the inability to digest lactose in dairy products, is also prevalent. A full 33% of all people are lactose intolerant, including 40% of adults, 90% Asians, and 75% African Americans. For these individuals, lactose is an irritant/indigestible component of the food that causes severe digestive upset. Dairy allergies, though less common than lactose intolerance, are more severe and can be life threatening, as can peanut and tree nut allergies.

The incidence of food allergies is on the rise, according to FARE. Among children, food allergies increased 50% between 2007-2011, and the Centers for Disease Control and Prevention documented an 18% increase in food allergies from 1997-2007.

There is no agreed upon consensus on why food allergies are becoming more common. But we do know the problem is not limited to the United States. A report by the World Health Organization (WHO) cited food allergies as “important health issues” in industrialized countries. And, despite the prevalence and increase in food allergies and intolerances, the treatments available for reactions are extremely limited.

The best defense for people with food allergies and intolerances is to avoid food containing the allergen or the irritant/indigestible component. People who are allergic to foods will usually carry medications like Benadryl and EpiPens to stop a dangerous reaction. Sometimes these medications do not work, however, and death can occur despite treatment. For those with gluten or lactose intolerances, there are over-the-counter digestive enzymes that can help avert a negative reaction. The enzymes are quite effective if taken before eating dairy products, but dramatically less effective for averting a negative reaction to gluten. So, the first line of defense for anyone with a food allergy or intolerance is to avoid the foods that trigger their reactions. This can be particularly difficult because of the risk of cross contact during food handling or production.

Contact by any of the major allergens with other foods can harm the health of allergic individuals, or even be fatal. People who live with food allergies and intolerances are exposed to daily risk of reaction because they may eat the foods they are avoiding. This may occur because of a mistake by the consumer. For example, the allergic person may not read an ingredient list accurately that clearly lists a major allergen as an ingredient. Or, the food may have trace amounts of food allergens (or foods that trigger intolerances) introduced into it by a food handler or piece of equipment previously used to process an allergenic ingredient and not thoroughly washed. Known as “cross contact” or “cross contamination,” this may occur in any number of places. For example, the mixing bowl used to make the food product may have had traces of the allergenic food in it from a previous use, or the person handling the food may introduce traces of a food to which someone may be allergic inadvertently through their hands, hair or clothing.

This can happen anywhere food is handled, including someone's private kitchen or a manufacturing or processing facility. And, it can happen anywhere along the supply and manufacturing chain, from the harvest of the ingredients to the packaging of the finished product. For example, an employee processing rice into flour may have peanut butter for lunch and small amounts of peanut butter make its way into the rice flour. Or, an industrial mixer used to make energy bars may have peanut or dairy residue on it from a previous product containing peanut and dairy made using the same equipment. Or, the allergen could be floating in the air in the manufacturing plant and land on food product.

Even miniscule amounts of cross contact can have damaging, even deadly effects. According to the Food Allergy Research and Resource Project (FAARP), the people most severely allergic to peanuts can have a fatal reaction to a mere 1/500^{th} of a peanut (2 PPM or “parts per million”), an amount that could literally float in the air from one piece of equipment to another. What makes this particularly risky for people who need to avoid foods to which they are allergic or intolerant is that the government does not require manufacturers take any steps to minimize cross contact, nor are they required to warn consumers of the potential for cross contact in the manufacturing process.

Efforts to minimizing cross contact are voluntary and vary by company, putting consumers at risk. Commonly, food companies do not operate their own manufacturing facility. Instead, manufacturing facilities will process food or produce food products for many companies. Though there is no federal requirement to do so, some of these shared manufacturing facilities voluntarily follow strict allergen control procedures to minimize the potential for cross contact. For example, they may clearly label potentially allergenic ingredients and store them in a specific part of the warehouse away from other ingredients. They may produce foods that do not contain any of the major food allergens only at the beginning of the production day or on dedicated equipment that is never used to process any of the top eight allergenic ingredients.

The procedures, however, are not a guarantee of safety, as there are many places in the manufacturing process where allergenic foods can be introduced, including ingredients sourced elsewhere and brought into the facility. Manufacturing facilities and the companies who use them typically do not test for the major allergens in ingredients and on manufacturing equipment because the number of tests would be prohibitively expensive and testing every piece of equipment multiple times per day is impractical.

As a result, a product labeled “peanut free” or does not have “peanuts” in the ingredients list could have deadly levels of peanut residue in it due to cross contact. Though many manufacturers take steps to minimize cross contact in their facilities, there is no regulatory requirement for them to do so. The Food and Drug Administration (FDA) under the authority granted it in the Food Allergen Labeling Consumer Protection Act (FALCPA) requires only that companies accurately label ingredients on the package and call attention to any major allergens in the ingredients list.

FDA consumer labeling protections address recipe ingredients only. There are few protections for food sensitive consumers, but those that exist are in the FALCPA. Under the FALCPA, the FDA requires that food products made with ingredients that are one of the eight major food allergens must list the allergen in the ingredient information on the package targeted for individual retail sale. [Note: Some drinks or foods are not under the jurisdiction of the FDA, so the rules on ingredient labeling for those drinks or foods can be more limited or even non-existent.] According to the FDA, the ingredient must be brought to the consumers' attention in one of two ways—either by bolding the specific ingredient in the ingredient list, such as, “rice, dairy, lentils and peanut,” or by using a “contains” statement after the ingredient list, such as, “Contains peanut and dairy.” All other statements about potential cross contact from any of the major food allergens that are not in the ingredients are voluntary. Notices like “may contain peanut” or “manufactured in a facility that also processes peanuts” are examples of voluntary labeling.

Voluntary labeling and non-standard wording among manufacturers leads to confusion that endangers health. FALCPA does not require any consumer notification of potential cross contact. Food companies typically alert consumers of potential cross contact in a number of ways on their packaging, websites, or other marketing materials. For example, they may use a broad disclaimer statement, such as, “Made in a facility that also processes peanuts” or “Made on shared equipment.” Still others may have no statement at all on their packaging even though cross contact is possible. Some manufacturers put disclaimers on all their food products, even if there is virtually no potential for cross contact, in hope that it will protect them from any possible allergen-related litigation.

An example of a product label is shown in FIG. 2. The label in FIG. 2 shows not only the disclaimer, but also the ingredients for the product. The ingredient list and the percent daily values shown on packages are based on the recipe. Typically, the packaging displaying the ingredient and daily value information is produced weeks to months prior to the production or processing of the actual food, making it difficult, if not impossible, to change the information on the packaging based on batch specific production information.

Here is an example of how voluntary labeling of the potential for cross contact might vary. Three energy bar companies may produce similar bars that do not have peanuts or dairy in their ingredients but are manufactured on equipment shared with other companies whose products do contain peanuts and dairy. One company puts a statement on their packaging saying, “Made on shared equipment.” A second uses the statement, “Made in a facility that also processes peanut and diary. Cross contact is possible.” The third, however, may not put any such statement on their package, even though they take no particular measures to avoid cross contact. This is confusing to consumers, as many are not aware that such statements are voluntary and may choose products without a disclaimer assuming them to be safer when in fact the opposite could be true—the company could be quite allergen unaware. Conversely, companies often choose to put on a disclaimer even though the possibility of cross contact is extremely low in hope that it will protect them legally from any potential law suits. FARRP reports the ubiquity of these disclaimers are resulting in consumers ignoring the warning statements altogether, which could be dangerous to their health.

FALCPA could be expanded to cover cross contact, directing the FDA to establish specific (1) procedures to minimize cross contact at manufacturing facilities, and (2) wording for statements and definition around when the statements can and cannot be used. However, this would provide procedural protection only—meaning, a consumer would know the certain procedures had been followed based on defined statements on the package. Such measures would not tell consumers if the specific food they want to purchase is likely to have cross contact by food allergens.

A superior step in consumer safety would be to test each batch of a food product for food allergens and make those test results available to consumers in a way that could help them be better informed when making immediate purchasing and consumption decisions.

### BRIEF DESCRIPTION OF THE FIGURES

FIG. 1 is a schematic diagram depicting an embodiment of the invention.

FIG. 2 depicts a label showing an ingredient list for a food product.

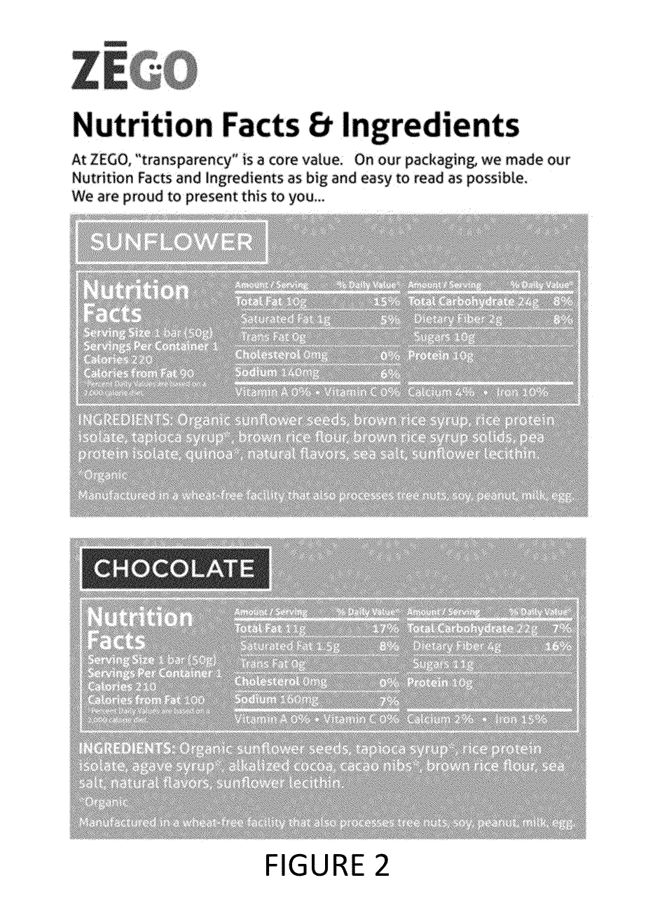

FIG. 3 depicts a label containing a QR code that identifies the batch from which the food product was made according to an embodiment of the invention.

### DESCRIPTION OF EMBODIMENTS OF THE INVENTION

It is possible to test food products as they are being made to see if there are any signs of cross contact. Companies can test any “batch”—which could be a single food (like roasted sunflower seeds), ingredients (like rice flour, pea protein or sunflower seeds) as well as the specific product made from a combination of ingredients (like a muffin or energy bar). For example, a company making a product with rice flour, lentil protein and sunflower seed butter could test each of those ingredients from their suppliers. During the manufacturing process, they could also mix the ingredients according to their recipe and test the finished product or at any point along the manufacturing process. Typically, testing may take one week before results are given to the manufacturer. Such testing is only helpful, however, if the consumer can access it at the time they are making a purchase and/or consumption decision.

Providing test results for major food allergens at the time of purchase and/or consumption would help consumers with food allergies and intolerances avoid negative health consequences from cross contact. An example of how this information could be used is as follows. Again, according to FARRP, peanut sensitivities range from 1/500th of a nut to 6 nuts, depending on the person. Using energy bars as an example, a sample could be taken from the batch from which the bar was made and tested for peanut residue. In this example, the testing results show a measurement of 2.5 PPM of peanut. This would mean the most sensitive allergic child would need to eat over half a kilogram of the bars (over 500 grams) in one sitting to risk a reaction. A parent, knowing this information, might feel confident giving a 50 gram energy bar to her child who has a peanut allergy. However, if the measure 1000 PPM, the parent may choose not to allow the child to eat the bar.

Embodiments of the invention make it possible to provide allergen testing results or other information specific to the batch with which a food or food product is associated to the consumer or purchaser at the point where they are making their food purchasing or consumption decision. For instance, it is possible to confirm the origin and integrity of ingredients after production has occurred in the event of an industry-related contamination or recall that may call those ingredients into question. It is also possible, for example, to provide information about the environment, labor, and process of production for a specific product industry-related questions or public scrutiny arise after production has occurred.

Embodiments of the invention could be used to provide data and information specific to the production or processing of a product, such as food, packaged food or food product from a first party, such as a supplier and manufacturer or farmer, to a second or third party, such as a manufacturer, retailer, or consumer or to a person the consumer needs approval from to purchase or consume the food (such as a child seeking approval from a parent). The information could also be provided to more than one person (such as both parents) or even a group of people that could consult on the purchase, such as a group of friends on a social media website like Facebook™, who may want to express their opinions of the prospective purchase. The provider of the data to the remote location might be done by a company via its website or other platform in which data is located or stored.

The invention is applicable to areas other than food, however, and could be used to provide a wide variety of batch information on a variety of different products. This information could include manufacturing information, such as issues related to labor, plant conditions, waste disposal, product recalls, or processing methods. It can also be contaminant information, such as issues related to environmental toxins, bacteria, allergens testing results, foods that consumers may be avoiding like major allergens or irritants, metals like lead and mercury, pesticides, chemicals, or recall information related to contaminants. Or it may be component information, such as suppliers, ingredients, processing agents or methods, component origin. Or it may be harvest information, such as growing methods, place of origin, impact on ecosystem such as endangered species or rainforests, or an explanation for why the product might look different than the consumer is used to seeing.

An example of a “batch” could be a production run unit or subunit or a recipe, such as ingredients processed together and put into a saleable form and packaged for distribution. A batch may produce a single unit or many units, such as 1 computer, 100 cakes, 1,000 cell phones, 300,000 energy bars, or 1000 gallons of soup.

A batch could also refer to a unit of a harvest. For example, it could be a harvest of grapes grown on a hillside section of a larger, mostly flat vineyard. Or, it could be apples grown in a certain section of an orchard. In some cases, the batch could be the entire harvest: e.g., the cherries grown by Farmer Brown this season in Michigan as distinguished from Farmer Joe in Maine who had to recall his cherries due to bacterial contamination that occurred during the washing and packaging process.

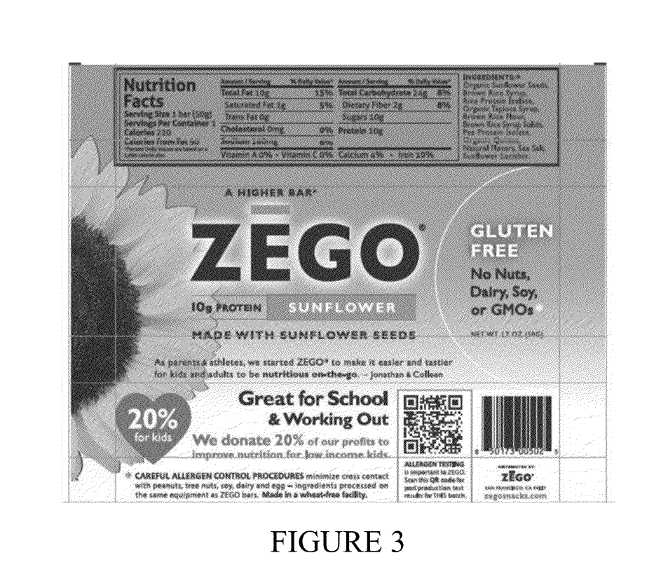

For example, a consumer or purchaser of a ZEGO™ energy bar could scan a QR code or other data-containing image on the label or package of the food or food product or a box of multiple units of a food or a food product. Such a QR code is illustrated in FIG. 3. This scan could be done with a general scanning device, such as a smartphone, tablet, or a wearable computer (such as Google Glass™) or it can be a unit that is specially designed for this purpose, such as an in-store scanning device or dedicated scanning device belonging to the consumer. Once the QR code or other image has been scanned, the consumer or purchaser would be provided information, such as data from a remote location, like a website page, that is not on the packaging and from which specific information about the batch can be obtained. For example, a batch-specific page may be automatically provided to the consumer or purchaser or the page may allow further interaction, allowing, for instance, the consumer to choose one or more of many batches (perhaps organized by production date). The data can be provided to the consumer (or, as indicated previously, a third person or group of people) via a number of transmission methods, such as on a webpage, in a text message, IM message, email, or a message on Twitter™ or a social media site.

Such manufacturing information would be information that is not available on the packaging and is specific to the batch from which that unit came. For example, in response to recent negative publicity about a competitor illegally disposing of waste, a manufacturer may want to inform consumers that the waste produced in the making of the product was disposed of according to EPA standards. Or a manufacturer may want to show an image of documentation indicating that the equipment was cleaned using a particular method prior to the production run. It might report how many days had passed since the plants last inspection by the local health department. It might state if a problem was discovered with that batch after production, for example, the product may be under voluntary recall. It might be used to communicate information like the origin and integrity of ingredients and location of the manufacturing facility after production has occurred in the event of an industry-related contamination or recall that may call those ingredients into question. It may provide information about the environment, labor and process of production for a specific product if industry-related questions or scrutiny arise after production has occurred.

An example of batch ingredient information specifically relevant to an industry recall could be as follows. If a source of sunflower seeds is determined to be contaminated with e coli bacteria and is reported in the general news media, it may raise concerns about products in general containing sunflower seeds. An example of information made available to the consumer about a specific product batch could be as follows, “The sunflower seeds used in making this ZEGO™ energy bar came were not affected in the e coli contamination recall of <date>, <location>, and <specific manufacturer>.”

The batch information also could give details about the supply chain for the ingredients in the food product in more detail than is printed on package. This could be information about where the ingredients for the product were grown or stored and the date, such as “The wheat used in this batch of brownies was grown in Iowa, harvested on Jan. 13, 2013” or “The sunflower seeds in this package were grown in the fall of 2013 in the U.S.A.” Another example could be, “This wine has a distinct ash flavor due to a fire in the field in which they were grown the previous year.” Or, “This bottle of wine comes from a small part of our vineyard where jalapenos were grown in the same field the prior year. As a result, the wine has a slight jalapeno flavor.”

Another example of batch ingredient information could be harvest information that provides an indication that the product batch is different from other batches harvested or manufactured by the same company, “This batch of grapes is larger than usual because the local river flooded a portion of our field during the growing season,” or “These apples are smaller than usual because we used experimented with a dry growing method for part of our acreage.” Or, the batch might be the entire harvest: “Our apples are smaller but sweeter than usual this year due to lack of rain.” Another example would be, “Our apples have small black dots on them this year due to soil changes but this does not affect the flavor or texture.”

In other embodiments, batch information includes information about foods or ingredients that can cause health problems, such as allergic reactions or digestive upset or other symptoms caused by food intolerances. Foods that most commonly cause these problems are the eight major food allergens—wheat, dairy, peanuts, tree nuts, soy, eggs, fish, shellfish—and foods to which people may be intolerant like gluten and dairy.

A recipe for a food product may contain an ingredient to which some people may be allergic or intolerant, e.g., people with nut or dairy allergies or a gluten or lactose intolerance. Because some people can tolerate small amounts of foods to which they are intolerant or allergic without problem (and in some cases people may be avoiding a food but have no allergy or intolerance to it), a manufacturer may want to let them know exactly how much of that ingredient is in the recipe. In such an instance, the information might say, “There is less than 1 gram of soy lethicin in the marinade used in this Tuscan lamb.” Another example would be, “This soup contains less than one teaspoon of wheat flour per 8 ounce serving.”

The information also could be about any foods not on the ingredient list that may be present in very small amounts in the food being sold due cross-contact from another non-ingredient food. For example, the information could be the results of testing done on a sample of the batch from which the food was made measuring minute amounts of a food that may have crossed over into the batch unintentionally or by mistake. For example, the information might be the test results of a sample from the batch from which that unit came that could show any measurable amounts of peanut, dairy, and gluten. These test results could show whether those foods were measured in the sample from that batch and the amount measured, despite the fact that they were not ingredients in the food or food product being sold.

For example, there might be a list such as this:

| | |
|---|---|
| Dairy | 1000 PPM |
| Peanut | <2.5 PPM (No measurable amount) |
| Gluten | 19 PPM |

A PPM, or part per million, is one millionth of a kilogram, a common measurement used when measuring for food allergens. In this example, someone with a peanut allergy may decide this food likely is safe for him or her to eat, while someone with a dairy allergy may decide it likely is not safe for him or her to eat.

In another example, the information could reveal more specific information about what exactly a gluten-free claim means. According to the FDA, a product is “gluten free” if it has <20 PPM of gluten in it. Some people extremely sensitive to gluten may only want to eat foods that are <5 PPM gluten. The information could reveal exactly how many PPM of gluten were in the sample from the batch from which the food was made. So, the product may say, “Certified gluten-free” and the batch testing information would say, “Test results for this batch showed less than 5 PPM gluten.” Because such testing might be completed several days post production, the results would not be known at the time the product was packaged or at the time the packaging was printed.

Contaminant information could include bacteria, chemicals, pesticides, or other things that are not intended to be in a food but may be present in individual batches due to contamination at any point in the growing or manufacturing process. One example is, “This batch of soup had no measurable levels of pesticides in it.”

In yet another example, a company may want to assure customers that an environmental disaster has not contaminated their product, “A sample from this batch of milk had no measureable amounts of radiation it.” Or, “Your health matters to us, so we test every batch of our tea for heavy metals. This batch tested negative for both lead and mercury.” Or, it could contain other information that changes over time, for example, “Tilapia is not an endangered fish.”

This information could identify any manufacturing processing agents, such as food enzymes or chemicals, that are not required to be listed in the ingredients but which consumers may be avoiding or allergic to. For example, “These tortilla chips were made with laccase.” Or, “This beer is made without propylene glycol or insect-based dyes.” Because this information is not required to be claimed by manufacturers in marketing materials or packaging, the data could change from one batch to the next without any type of consumer notification.

In another example, information could be provided relevant to the product batch that relates to the environment in which it was produced. This could pertain to any number of factors, including the labor force, the workplace conditions, or the manufacturers' practices. For instance, a practice of unfavorable working conditions or child labor is discovered at a specific sunflower processing plant. In this instance, information could be provided that clarifies and confirms the working conditions of the specific sunflower processing plant used for the ingredients in a ZEGO™ bar batch. “The sunflower seeds in this batch of ZEGO™ bars came from sources that have been confirmed to comply with all labor laws.”

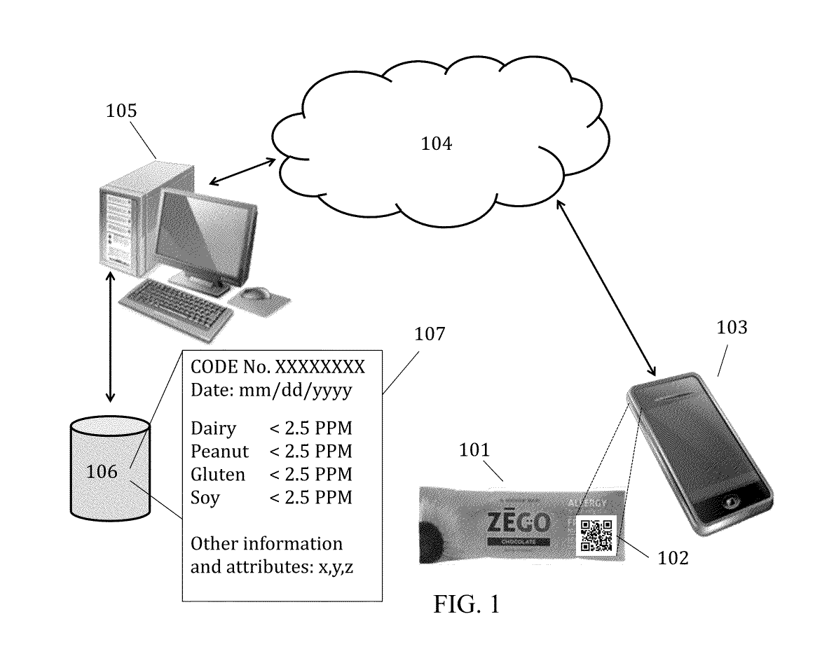

A sample system according one embodiment of the invention is illustrated in FIG. 1. A consumer operating a smart phone (103) scans the QR code (102) on a food package (101). The smart phone then transmits data associated with the QR code through a network, such a cellular network or the Internet (104). The QR data is then received at a data-receiving input at a server (105). The server can be operated by the food product manufacturer or by a third party on the manufacturer's behalf, or even by a completely unrelated third party, such as a certifying agency or advocacy group. The server then accesses a memory (106) that contains batch data (107) for the product. The memory can be any suitable memory device, such as a magnetic, optical, or semiconductor (flash) media. The QR code data is used to locate the appropriate batch data. In this example, the batch data includes the content of three allergens: dairy, peanuts, and gluten. This batch data is then transmitted by the server (105) back though the network (104) to the consumer's smart phone (103). The consumer or purchaser can then make an informed decision about whether to buy the product.

Products containing the batch-identifying code can be a single, separately packaged product or it can be a group of products packaged together with a digital code or image on the packaging. The identifying information in this example is a QR code, but it can be any suitable identifier, such as a bar code or other image. It could be pre-printed on the packaging or entered on or after the day of production with a stamp, sticker, or other means. Identifying information can also be contained on a radio-frequency identifying (RFID) chip or tag or magnetic strip, or received via Bluetooth technologies, including those described in http://techcrunch.com/2013/12/06/apple-ibeacons-u-s-retail-app-store/ or http://techcrunch.com/2014/01/16/shopkick-starts-100-store-ibeacon-trial-for-american-eagle-outfitters-the-biggest-apparel-rollout-yet/ or http://techcrunch.com/2013/11/07/apple-iwatch-bluetooth-le-network-patent/

What we claim is:

1. A method of providing information about a product, said method comprising:
receiving data from a remote location identifying a product;
obtaining batch information about said product; and
transmitting said batch information about said product.

2. The method of claim 1, wherein
said batch information is transmitted to the remote location.

3. The method of claim 1, wherein
said batch information is transmitted to a social media site.

4. The method of claim 1, wherein
said batch information about said product includes manufacturing information.

5. The method of claim 1, wherein
said batch information about said product includes component information.

6. The method of claim 1, wherein
said batch information about said product includes harvest information.

7. The method of claim 1, wherein
said batch information about said product includes at least one of allergen or cross-contact information.

8. The method of claim 1, wherein
said batch information about said product includes contaminant information.

9. A system for providing information about a product, said system comprising:
a data-receiving input for receiving data from a remote location that identifies a product;
a memory that contains batch information about said product; and
a data-transmitting output for providing said batch information about said product.

10. The system of claim 9, wherein
said batch information about said product includes manufacturing information.

11. The system of claim 9, wherein
said batch information about said product includes component information.

12. The system of claim 9, wherein
said batch information about said product includes harvest information.

13. The system of claim 9, wherein
said batch information about said product includes at least one of allergen or cross-contact information.

14. The system of claim 9, wherein
said batch information about said product includes contaminant information.

15. A method of obtaining information about a product, said method comprising:
transmitting data identifying a product to a remote location;
obtaining batch information about said product from said remote location.

16. The method of claim 15, wherein
said batch information about said product includes manufacturing information.

17. The method of claim 15, wherein
said batch information about said product includes component information.

18. The method of claim 15, wherein
said batch information about said product includes harvest information.

19. The method of claim 15, wherein
said batch information about said product includes at least one of allergen or cross-contact information.

20. The method of claim 15, wherein
said batch information about said product includes contaminant information.
